(19) United States
(12) Patent Application Publication
(10) Pub. No.: US 2003/0229671 A1
(43) Pub. Date: Dec. 11, 2003

(54) E-mail communication system

(75) Inventors: Hitoshi Kadomatsu, Tokyo (JP); Kenji Kuwabara, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/457,345

(22) Filed: Jun. 9, 2003

(30) Foreign Application Priority Data
Jun. 11, 2002 (JP) 2002-170119

(51) Int. Cl. G06F 15/16

(52) U.S. Cl. 709/206

(57) ABSTRACT

An e-mail communication system, in which bothering e-mails can be prevented to transmit to recipients, is provided. In case that a sender (subscriber) connected to an Internet service provider transmitted an e-mail to recipients (subscribers) connected to the Internet service provider, when the e-mail was an unwelcome e-mail (bothering e-mail) to the recipients, each of the recipients transmit a refusal notice to a data server for addresses transmitted refusal e-mails by using e-mails via an e-mail server provided by the Internet service provider. The data server for addresses transmitted refusal e-mails stores the transmitted refusal notices. When the number of the refusal notices per a unit period exceeded a threshold value, the Internet service provider makes the sender stop transmitting e-mails from now on.

### BACKGROUND OF THE INVENTION

The present invention relates to an e-mail communication system that executes e-mail communication, in particular, in which a situation that e-mails are transmitted to recipients regardless of the intention of the recipients can be prevented.

### DESCRIPTION OF THE RELATED ART

Recently, e-mails have been frequently transmitted and received by using information processing equipment such as personal computers (PCs) and mobile communication terminals. However, an e-mail can be easily transmitted to e-mail addresses when a sender knows the e-mail addresses. Further, the sender can transmit the e-mail to a large number of the e-mail addresses with a small amount of communication expenses. By the situation mentioned above, a large number of e-mails have been transmitted to recipients without the intention of the recipients. With this, a large load has been imposed on the e-mail transmitting sever, and also an undesirable communication charge has been imposed on the recipients.

In order to solve this problem, several measures, which prevent these unwelcome e-mails, have been proposed. Hereinafter, the unwelcome e-mails are referred to as bothering e-mails. For example, in a proposal, e-mails whose destinations are unidentified are detected, and legal measures are taken to senders that transmitted the e-mails having unidentified destinations. Or, in another proposal, preventing the transmission of the bothering e-mails is requested to an Internet service provider who has a contract with the sender that transmits the bothering e-mails.

However, at the proposal that takes the legal measures, when the sender changed its name or its address, the legal measures are not effective, and the legal measures must be taken repeatedly. Further, at the proposal that the Internet service provider is requested to prevent to transmit the bothering e-mails, the Internet service provider must investigate the sender transmitting the bothering e-mails, and it takes time to make the sender stop transmitting the bothering e-mails.

Japanese Patent Application Laid-Open No. HEI 4-207735 discloses an e-mail management apparatus. In this patent application, in case that a user does not want to receive e-mails from a designated sender, the user registers the address of the designated sender. And when an e-mail whose address is equal to the address of the registered sender is transmitted to the user, the e-mail is not stored.

At this patent application, it is effective for only the user who registered the address of the sender from whom the user does not want to receive e-mails again, and it is not effective for the other users who have not registered the address of the sender. Further, in case that there are many other senders that transmit bothering e-mails, the user must always register the addresses of the other senders that transmit bothering e-mails.

Japanese Patent Application Laid-Open No. 2001-84192 discloses an e-mail receiving apparatus, an e-mail receiving method and a recording medium for storing the method. In this patent application, the kind of language of an e-mail that was transmitted to a recipient is recognized, and when the language was recognized as the recipient own country's language, the e-mail is stored in an e-mail storing section. And the other e-mails are judged as bothering e-mails and are blocked to receive. With this, the e-mails written by the other languages are stopped receiving immediately. However, e-mails using the other languages from his/her friends or clients are completely blocked to receive, therefore, there is a problem that necessary e-mails using the other languages are not received. Further, almost all the bothering e-mails are written by the recipient own country's language, therefore this method does not have advantage for preventing the reception of the bothering e-mails.

Japanese Patent Application Laid-Open No. 2002-73492 discloses an e-mail server, an e-mail service method, and an information recorded medium of the method. In this patent application, the e-mail server receives an e-mail; and the e-mail server judges whether the destination address of the e-mail is the address of a user's open address, which is managed by the e-mail server, or not. And the destination of the e-mail was the address of the user's open address, the e-mail server inquires the user about the permission of transmitting the e-mail to the user. When the permission was not given, the e-mail server informs the sender of the e-mail about that the user does not exist. When the permission was given, the e-mail is transmitted to the user having the open address.

However, at this patent application, the user can receive e-mails from only the senders whom the user gave the permission of transmitting e-mails. Consequently, e-mails from the senders whom the permission was not given can not be received. For example, in case that inquiries for the web site of the user are transmitted to the user, or in case that the e-mail address of the user is used for the inquiries of customers in business, the e-mails from these inquires are not received by the user. Further, the addresses of the senders, who are permitted to transmit e-mails to the user, must be registered beforehand, therefore, the processes become complicated.

In order to prevent the bothering e-mails, another technology is proposed. In this technology, at a multi-address calling, which transmits an e-mail to plural e-mail addresses simultaneously, when there are many unidentified e-mail addresses in the plural e-mail addresses, this message is judged as a bothering e-mail. And servers that receive this e-mail block the transmission of this e-mail.

In this technology, when a sender made lots of e-mail addresses by generating random English letters and figures and there are many e-mail addresses being equal to actual e-mail addresses in the made e-mail addresses, in case that the sender transmits an e-mail to the made e-mail addresses, the e-mail can be blocked, because there are a lot of unidentified e-mail addresses.

However, in case that the unidentified e-mail addresses are not many, the e-mail is transmitted to the actual e-mail addresses without the approval of the users of the actual e-mail addresses.

Some e-mails, which are transmitted without the approval of recipients, are useful for the recipients. For example, a notice from a government office or information from alumni is useful for the recipients, even when the approval of the recipients is not given. Therefore, as mentioned above, in case that the user limits the senders of the e-mails, there is a problem that the recipient cannot receive a message from senders such as the government office or the alumni.

### SUMMARY OF THE INVENTION

It is therefore an object of the present invention to provide an e-mail communication system, in which bothering e-mails can be prevented to transmit to recipients.

According to a first aspect of the present invention, for achieving the object mentioned above, there is provided an e-mail communication system. The e-mail communication system provides an e-mail transmitting means that transmits e-mails of each of subscribers to respective destinations, an e-mail transmission refusal notice receiving means that receives a transmission refusal notice signifying that a specific e-mail is not desired to receive at each of the destinations and also showing the sender of the specific mail by an-e-mail, a judging means that judges whether the number of the transmission refusal notices received at the e-mail transmission refusal notice receiving means for each of the senders in a designated period exceeds a predetermined threshold value or not, and an e-mail transmission refusing means that refuses the transmission of e-mails from the sender from now on when the judging means judged that the number of the refusal notices for the sender exceeded the predetermined threshold value.

According to a second aspect of the present invention, for achieving the object mentioned above, there is provided an e-mail communication system. The e-mail communication system provides an e-mail transmitting means that transmits e-mails of each of subscribers to respective destinations, an e-mail transmission refusal notice receiving means that receives a transmission refusal notice signifying that a specific e-mail is not desired to receive at each of the destinations and also showing the sender of the specific mail by an-e-mail, a judging means that judges whether the ratio of the number of the transmission refusal notices received at the e-mail transmission refusal notice receiving means for the specific e-mail from each of the senders to the total transmitted number of the specific e-mail exceeds a predetermined threshold value or not, and an e-mail transmission refusing means that refuses the transmission of e-mails from the sender from now on when the judging means judged that the ratio exceeded the predetermined threshold value.

According to a third aspect of the present invention, in the first aspect, the e-mail communication system further provides an e-mail transmission refusal notice informing means that informs the sender who transmitted the specific e-mail being not desirable to receive about the transmission refusal notices received at the e-mail transmission refusal notice receiving means.

According to a fourth aspect of the present invention, in the second aspect, the e-mail communication system further provides an e-mail transmission refusal notice informing means that informs the sender who transmitted the specific e-mail being not desirable to receive about the transmission refusal notices received at the e-mail transmission refusal notice receiving means.

According to a fifth aspect of the present invention, in the first aspect, the e-mail communication system further provides a transmission refused sender memorizing means that memorizes each of the senders who were refused to transmit the e-mails from now on by the e-mail transmission refusing means, and a threshold value changing means that makes the predetermined threshold value low when the memorized number of the sender in the transmission refused sender memorizing means increased.

According to a sixth aspect of the present invention, in the second aspect, the e-mail communication system further provides a transmission refused sender memorizing means that memorizes each of the senders who were refused to transmit the e-mails from now on by the e-mail transmission refusing means, and a threshold value changing means that makes the predetermined threshold value low when the memorized number of the sender in the transmission refused sender memorizing means increased.

According to a seventh aspect of the present invention, for achieving the object mentioned above, there is provided an e-mail communication system. The e-mail communication system provides a transmission refusal e-mail storing means that stores specific e-mails being not desirable to receive at each of destinations in each of senders when the specific e-mails being not desirable to receive were received at each of the destinations, provided in a network, and an e-mail transmission stopping request transmitting means that investigates the number of the specific e-mails in each of the senders storing in the transmission refusal e-mail storing means and makes an Internet service provider connected to each of the senders stop transmitting e-mails from each of the senders from now on when the number of the specific e-mails exceeded a predetermined value in a designated period via the network.

According to an eighth aspect of the present invention, in the seventh aspect, the e-mail communication system further provides a transmission refusal e-mail transmitting back means that transmits back the specific e-mails being not desirable to receive to each of the senders storing in the transmission refusal e-mail storing means.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a structure of an e-mail communication system at a first embodiment of the present invention;

FIG. 2 is a diagram showing processes at the time when a bothering e-mail was transmitted at the structure of the e-mail communication system shown in FIG. 1;

FIG. 3 is a diagram showing a part of data storing in a data server for addresses transmitted refusal e-mails shown in FIG. 1;

FIG. 4 is a block diagram showing a structure of an e-mail communication system at a second embodiment of the present invention; and

FIG. 5 is a flowchart showing the operation of a server for watching refusal e-mails shown in FIG. 4.

### DESCRIPTION OF THE PREFERRED EMBODIMENTS

Referring now to the drawings, embodiments of the present invention are explained in detail.

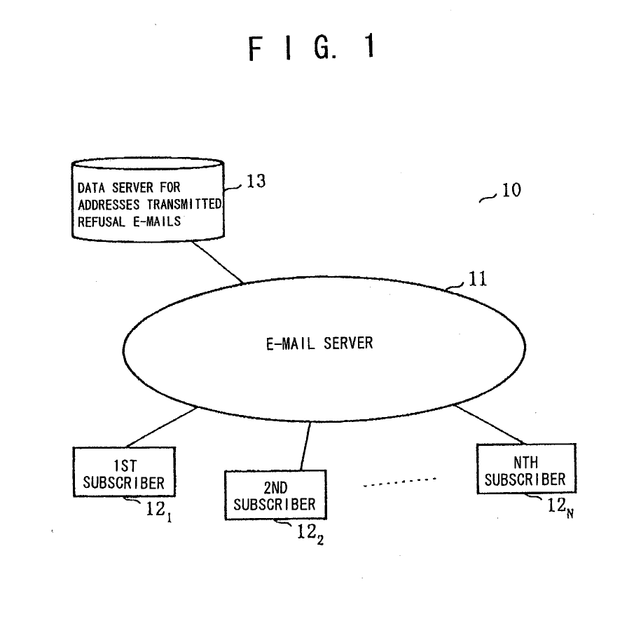

FIG. 1 is a block diagram showing a structure of an e-mail communication system at a first embodiment of the present invention. By using this e-mail communication system, bothering e-mails can be prevented to transmit within subscribers connected to one Internet service provider. As shown in FIG. 1, an e-mail communication system 10 of the first embodiment of the present invention provides an e-mail server 11, subscribers 12ᵢ to 12_{N}, and a data server for addresses transmitted refusal e-mails 13. The e-mail server 11 is provided by an Internet service provider. The subscribers 12₁ to 12_{N} communicate with one another by using e-mails via the e-mail server 11. The data server for addresses transmitted refusal e-mails 13 stores. e-mail addresses of senders who transmitted e-mails that recipients did not want to receive. The subscribers 12₁ to 12_{N} are e-mail clients such as PCs, work stations, and mobile communication terminals.

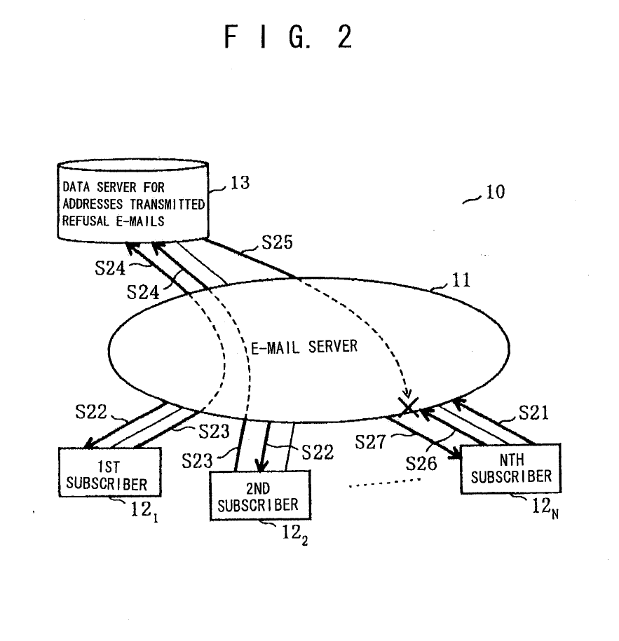

FIG. 2 is a diagram showing processes at the time when a bothering e-mail was transmitted at the structure of the e-mail communication system shown in FIG. 1. Referring to FIG. 2, the processes at the time when a bothering e-mail is transmitted are explained. In the explanation of the processes, each of the step numbers is shown in FIG. 2.

First, the first half of the processes is explained. In this example, it is assumed that the Nth subscriber 12_{N} transmitted an e-mail to arbitrary many subscribers by the multi-address calling (step S21). By this transmission, in FIG. 2, the first subscriber 12₁ and the second subscriber 12₂ receive this e-mail via the e-mail server 11 (step S22).

In this, at this e-mail communication system 10, the Internet service provider, which manages the e-mail server 11, has informed the subscribers 12₁ to 12_{N} about a process preventing bothering e-mails. The process preventing bothering e-mails is the following process. In case that a recipient received an e-mail that was not welcome from a sender, when the recipient wants to refuse to receive any e-mails from the sender after this time, the recipient transmits a refusal notice, which informs the refusal of receiving e-mails form the sender, by an e-mail to the e-mail server 11 by clearly showing the sender.

Therefore, when the e-mail that was transmitted by the Nth subscriber 12_{N} at the step S21 was a bothering e-mail, many subscribers such as the first and second subscribers 12₁ and 12₂ transmit the refusal notices to the e-mail server 11 by using e-mails (step S23). The e-mail server 11 registers the refusal notices in the data server for addresses transmitted refusal e-mails 13 in each of senders (step S24).

In this, instead of using the e-mails, when the subscribers received e-mails that were not welcome, the subscribers can inform the Internet service provider, which manages the e-mail server 11, about the refusal notices by using a telephone call or a document. In this case, the Internet service provider registers the refusal notices in the data server for addresses transmitted refusal e-mails 13.

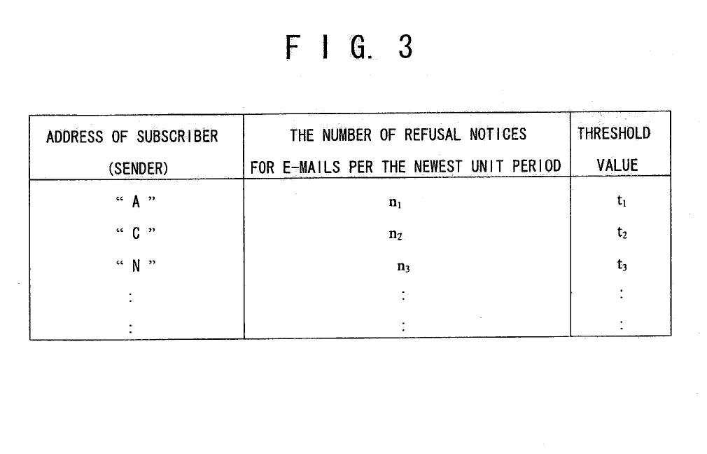

FIG. 3 is a diagram showing a part of data storing in the data server for addresses transmitted refusal e-mails 13 shown in FIG. 1. As shown in FIG. 3, the addresses of subscribers, the number of refusal notices for e-mails per the newest unit period for each of the addresses of subscribers, and a threshold value for each of the number of refusal notices for e-mails are stored in the data server for addresses transmitted refusal e-mails 13. The addresses of subscribers are the addresses of senders to whose e-mails the refusal notices were given from some subscribers. The number of refusal notices for e-mails per the newest unit period is the number of refusal notices per the newest unit period for each of the addresses of senders. The threshold value for each of the number of refusal notices for e-mails is a minimum value to judge whether an e-mail is a bothering e-mail or not. That is, in case that the number of refusal notices exceeded the threshold value, the e-mail is judged as a bothering e-mail.

For example, in FIG. 3, when the subscriber address “N” of the Nth subscriber 12_{N} is focused on, the number of refusal notices for e-mails per the newest unit period is n₃, and the threshold value is t₃. In this, the number of refusal notices for e-mails is counted per the newest unit period, this comes from the following reason. That is, when the number of refusal notices for e-mails is simply accumulated for a long period, the number of refusal notices for e-mails from many of the subscribers 12₁ to 12_{N} is increased after the long period, and the transmission of bothering e-mails cannot be prevented quickly. The unit period can be arbitrarily decided as, for example, one hour. As the threshold value, the same value can be used for all the subscribers 12₁ to 12_{N}, but the Internet service provider can decide the threshold value for each of the subscribers 12₁ to 12_{N} arbitrarily corresponding to the situation. Or in case that a subscriber was judged as a sender of bothering e-mails in the past, the threshold value for the address of the subscriber (sender) can be set to be a low value. With this, the bothering e-mails can be stopped quickly.

The number of refusal notices for e-mails per the newest unit period can be counted by various methods. For example, when the e-mail server 11 received a refusal notice from a subscriber, the e-mail server 11 adds the time information when the refusal notice was given to the address of the subscriber (sender) that transmitted the e- mail given the refusal notice. And the added results are transmitted to the data server for addresses transmitted refusal e-mails 13. In case that the unit period is decided as one hour, the data server for addresses transmitted refusal e-mails 13 extracts the number of refusal notices for one hour from the present to the past by using the time information, and counts the number of refusal notices and stores it.

Next, referring to FIGS. 2 and 3, the second half of the processes is explained. For example, the following case is assumed. That is, after the Nth subscriber 12_{N} transmitted a large quantity of an e-mail, the refusal notice for the e-mail transmitted from the Nth subscriber 12_{N} is transmitted to the data server for addresses transmitted refusal e-mails 13 via the e-mail server 11, and the number of refusal notices for e-mails per the newest unit period n₃ exceeded the threshold value t₃. At this time, the data server for addresses transmitted refusal e-mails 13 transmits a stop signal, which makes the Nth subscriber 12_{N} stop transmitting an e-mail from now on, to the e-mail server 11 (step S25). When the e-mail server 11 received the stop signal, the e-mail server 11 forbids the Nth subscriber 12_{N} to transmit e-mails from now on (step S26). And also the e-mail server 11 transmits an e-mail, informing that the Nth subscriber 12_{N} cannot transmit e-mails from now on because the Nth subscriber 12_{N} can be a source of bothering e-mails, to the Nth subscriber 12_{N} (step S27). The process at the step S27 has the following purposes. The first purpose is to make the Nth subscriber 12_{N} not transmit bothering e-mails from now on by informing the Nth subscriber 12_{N} about the reason why the Nth subscriber 12_{N} cannot transmit e-mails from now on. The second purpose is to give the Nth subscriber 12_{N} an opportunity that the Nth subscriber 12_{N} can transmit e-mails again by assuming a case that the Nth subscriber 12_{N} transmitted the e-mail to an indefinite number of addresses by mistake.

When the Nth subscriber 12_{N} wants to restart transmitting e-mails, the Nth subscriber 12_{N} transmits an e-mail for requesting restart of the transmission of e-mails to the e-mail server 11. When the e-mail server 11 judged the restart of the transmission of the e-mails from the Nth subscriber 12_{N}, the e-mail server 11 makes the data server for addresses transmitted refusal e-mails 13 let the number of refusal notices for e-mails per the newest unit period “0”.

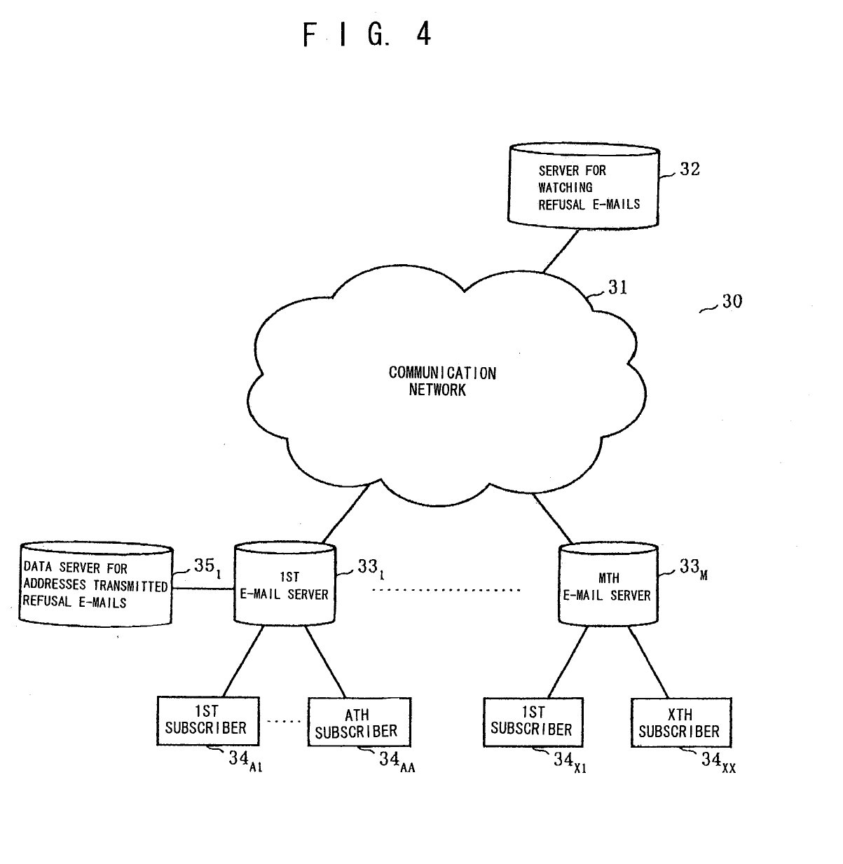

Next, referring to the drawings, a second embodiment of the present invention is explained. FIG. 4 is a block diagram showing a structure of an e-mail communication system at the second embodiment of the present invention. At the first embodiment of the present invention, generating bothering e-mails among subscribers of the same Internet service provider is prevented. However, at the second embodiment of the present invention, generating bothering e-mails among subscribers of plural Internet service providers is prevented.

As shown in FIG. 4, an e-mail communication system 30 at the second embodiment provides a communication network 31, a server for watching refusal e-mails 32, a first e-mail server 33₁ to an Mth e-mail server 33_{M}, a first subscriber 34_{A1} to an Ath subscriber 34_{AA} connected to the first e-mail server 33₁, a first subscriber 34_{X1} to an Xth subscriber 34_{XX} connected to the Mth e-mail server 33_{M}, and a data server for addresses transmitted refusal e-mails 35₁. In FIG. 4, only the data server for addresses transmitted refusal e-mails 35₁ is shown, however, in the first e-mail server 33₁ to the Mth e-mail server 33_{M}, any of e-mail servers can provide the data server for addresses transmitted refusal e-mails 35.

The communication network 31 is a network such as the Internet. The server for watching refusal e-mails 32 is connected to the communication network 31, and watches the existence of e-mails not desiring to receive in the communication network 31, and prevents the generation of the e-mails not desiring to receive in designated cases. The servers of the first e-mail server 33₁ to the Mth e-mail server 33_{M} are also connected to the communication network 31. And each of the servers of the first e-mail server 33₁ to the Mth e-mail server 33_{M} is provided by a corresponding Internet service provider.

As mentioned above, a part of the servers of the first e-mail server 33₁ to the Mth e-mail server 33_{M} provides the data server for addresses transmitted refusal e-mails 35. The function of the data server for addresses transmitted refusal e-mails 35 is equal to that of the data server for addresses transmitted refusal e-mails 13 at the first embodiment. For example, in FIG. 4, the following case is assumed, that is, the first e-mail server 33₁ provides the data server for addresses transmitted refusal e-mails 35₁, and the Mth e-mail server 33_{M} does not provide the data server for addresses transmitted refusal e-mails 35. In this case, at the first e-mail server 33₁, which provides the data server for addresses transmitted refusal e-mails 35₁, as the same as at the first embodiment, e-mails not desiring to receive can be prevented among the subscribers 34_{A1} to 34_{AA}, by the control of the first e-mail server 33₁.

At the e-mail communication system 30 of the second embodiment of the present invention, by applying the same control at the first embodiment, in case that many e-mails not desiring to receive exist in the e-mails transmitted from other e-mail server, these e-mails not desiring to receive are informed to the other e-mail server. With this, bothering e-mails can be prevented to receive at the subscribers. At the second embodiment of the present invention, by making the server for watching refusal e-mails 32 work, the generation of the bothering e-mails can be prevented largely. That is, even a case that an e-mail server does not have a function to prevent the generation of the bothering e-mails, or a case that e-mails are transmitted among plural e-mail servers provided by Internet service providers, by making the server for watching refusal e-mails 32 work, the generation of the bothering e-mails can be prevented largely.

For example, a case is assumed. That is, the first subscriber 34_{X1} connected to the Mth e-mail server 33_{M}, which does not provide the data server for addresses transmitted refusal e-mails 35, transmitted a large quantity of an e-mail to the subscribers connected to the first e-mail server 33₁. In this case, when the control at the first embodiment is applied, the e-mails, which were transmitted from the e-mail server 33_{M}, are not watched by the e-mail server 33₁. That is, transmitting such e-mail cannot be controlled, when the control at the first embodiment is applied.

However, at the second embodiment of the present invention, in the case mentioned above, the Mth e-mail server 33_{M} can be controlled. In order to achieve this control, at the second embodiment of the present invention, when a subscriber (recipient) received an undesirable e-mail, the recipient forwards the e-mail to the server for watching refusal e-mails 32. For example, the first subscriber 34_{A1} connected to the first e-mail server 33₁ or a first subscriber 34_{B1} (not shown) connected to the second e-mail server 33₂ (not shown) forwards the received e-mail to the server for watching refusal e-mails 32.

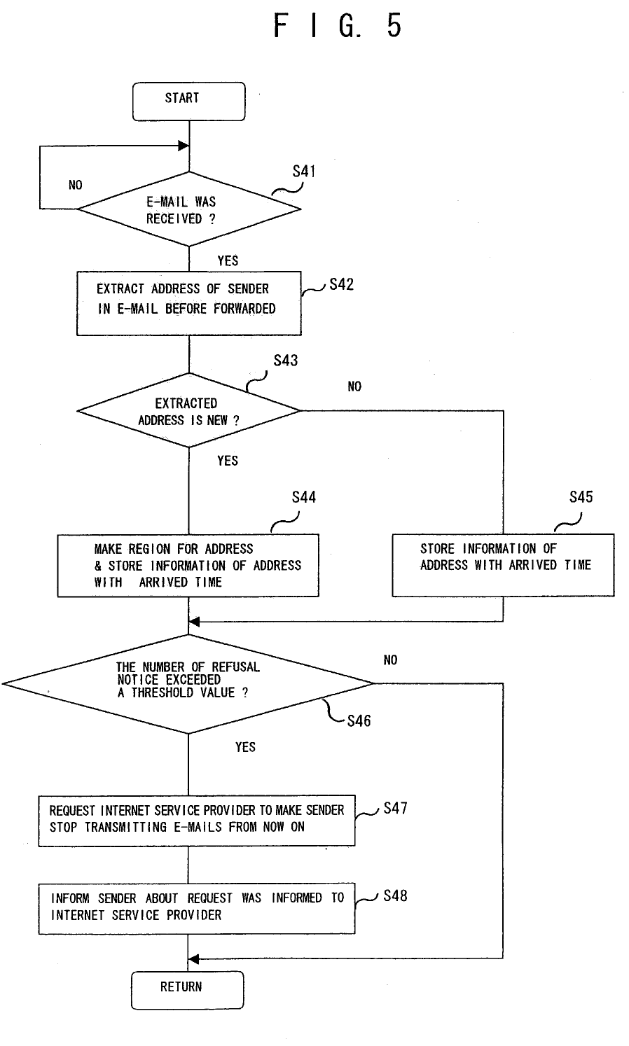

FIG. 5 is a flowchart showing the operation of the server for watching refusal e-mails 32 shown in FIG. 4. Referring to FIG. 4, the operation of the server for watching refusal e-mails 32 is explained. The server for watching refusal e-mails 32 provides a central processing unit (CPU) (not shown) and a control program written in a recording medium (not shown), and controls the operation by using the control program under the instruction of the CPU.

In the explanation of the operation of the server for watching refusal e-mails 32, a case, in which the first subscriber 34_{X1} connected to the Mth e-mail server 33_{M} transmits an e-mail to the first subscriber 34_{A1} connected to the first e-mail server 33₁, is assumed.

First, the server for watching refusal e-mails 32 receives an e-mail, which is an e-mail being not desiring to a subscriber (recipient) and was forwarded from the subscriber (step S41). That is, this e-mail is a refusal e-mail at the subscriber, and receiving the refusal e-mail signifies receiving refusal notice for the e-mail. When the refusal e-mail was received (YES at the step S41), the server for watching refusal e-mails 32 extracts the address of a subscriber (sender) in the e-mail before forwarded (step S42). In this example, the address of the first subscriber 34_{X1} connected to the Mth e-mail server 33_{M} was extracted. The server for watching refusal e-mails 32 judges whether this extracted address is new or not (step S43). When the extracted address is new (YES at the step S43), the server for watching refusal e-mails 32 makes a region where information about this extracted address is recorded, and the arrived time of the e-mail to the server for watching refusal e-mails 32 is set, and the information including the arrived time is stored (step S44). The information in the region is the same shown in FIG. 3 at the first embodiment of the present invention. That is, when 1 e-mail arrived, 1 is counted as the number of refusal notices for the e-mails.

When the extracted address is an address that has been already stored in the server for watching refusal e-mails 32 (NO at the step S43), the server for watching refusal e-mails 32 stores the information of the extracted address with the arrived time of the e-mail in the already set region (step S45). And as mentioned at the first embodiment of the present invention, the server for watching refusal e-mails 32 accumulates the number of arrived e-mails (refusal notices for the e-mail) per the newest unit period counting from the present to the past. And the server for watching refusal e-mails 32 judges whether the accumulated number exceeds a predetermined threshold value or not (step S46). When the accumulated number has not exceeded the threshold value (NO at the step S46), it cannot be judged that the e-mail is a bothering e-mail, therefore, the operation returns to the start.

When the accumulated number exceeded the threshold value (YES at the step S46), the server for watching refusal e-mails 32 identifies an Internet service provider to which the subscriber (sender) of the e-mail has subscribed, from the address (character and/or figure and/or sign string) of the sender. And the server for watching refusal e-mails 32 requests the Internet service provider to make the subscriber (sender) stop transmitting e-mails. In this example, an Internet service provider, to which the first subscriber 34_{X1} has subscribed, is identified, and the identified Internet service provider is requested to inform the first subscriber 34_{X1} so that the first subscriber 34_{X1} stops transmitting e-mails. In this, this Internet service provider is an Internet service provider that manages the Mth e-mail server 33_{M}. In this case, there is a possibility that the e-mail from the first subscriber 34_{X1} is a bothering e-mail. Therefore, the server for watching refusal e-mails 32 requests the Internet service provider managing the Mth e-mail server 33_{M} to make the first subscriber (sender) 34_{X1} stop transmitting e-mails from now on (step S47). At this time, the number of recipients who forwarded the e-mail to the server for watching refusal e-mails 32 as that the e-mail was a not welcomed e-mail, or details of the recipients such as the names of the Internet service providers of the recipients can be attached to the request.

When an Internet service provider received a request not to transmit e-mails from a subscriber, the Internet service provider does not always take an action for making the corresponding subscriber stop transmitting e-mails immediately. However, by the reception of the request and the attached information, it can be expected that the Internet service provider takes a suitable action for the corresponding subscriber by the responsibility for the public as the Internet service provider. When the server for watching refusal e-mails 32 has achieved its purpose, its influence becomes large.

The server for watching refusal e-mails 32 also informs the subscriber (sender) of the refusal e-mail about that the request not to transmit e-mails was informed to the Internet service provider of the sender (step S48). At this time, the information such as the number of recipients can be attached to the sender. In this example, the information was transmitted to the first subscriber 34_{X1}. As the same as at the first embodiment of the present invention, the operation at the step S48 has the following purposes. The first purpose is to make the subscriber 34_{X1} recognize the facts and not transmit bothering e-mails from now on. The second purpose is to make the subscriber 34_{X1} remove the cause when the facts happened by mistake.

At the second embodiment of the present invention as the same as at the first embodiment of the present invention, when the first subscriber 34_{X1}, who had transmitted a bothering e-mail in the past, transmitted another bothering e-mail again, the threshold value in the server for watching refusal e-mails 32 can be lowered. Further, there is a case that the instruction from the Internet service provider to the subscribers is not good. In this case, when plural subscribers (senders) connected to the Internet service provider are requested not to transmit e-mails by the server for watching refusal e-mails 32, the threshold value for each of the plural subscribers in the server for watching refusal e-mails 32 can be lowered. Or instead of changing the threshold value, changing the unit period for accumulating the number of refusal notices has the same effect.

Further, in some cases, it is effective that the e-mails forwarded to the server for watching refusal e-mails 32 are transmitted back to an original sender (subscriber) who transmitted a bothering e-mail. By this transmission back, the sender who transmitted the bothering e-mail receives a large quantity of the e-mails form the subscribers who refused to receive the bothering e-mail.

At the first and second embodiments of the present invention, the number of refusal notices for e-mails per the newest unit period is counted, and the counted number of refusal notices is compared with a threshold value. With this comparison, it is judged whether a bothering e-mail exists or not. However, the judging method is not limited to the method mentioned above. For example, when the total number of destinations, to which an e-mail was transmitted, is known, since the number of refusal notices for the e-mail is known, the ratio of the number of refusal notices to the total number can be calculated. Therefore, when this ratio is high enough compared to that at usual transmission of an e-mail, the e-mail having this high ratio can be judged as a bothering e-mail that is transmitted to plural recipients without the intention of the recipients. Consequently, the subscriber (sender) of the bothering e-mail can be regulated.

As mentioned above, according to the embodiments of the present invention, an Internet service provider and a subscriber (sender) who transmitted an e-mail, connected to the Internet service provider, receive a refusal notice signifying that recipients of the e-mail do not desire to receive the e-mail with the identification of the sender by e-mails from the recipients. Therefore, transmitting e-mails from the sender is regulated based on the results of the reaction of the recipients that are designated by the sender. Consequently, since the intention of the recipients is transmitted to the sender, it is possible to regulate the sender convincingly.

According to the embodiments of the present invention, when recipients receive an e-mail that the recipients do not desire to receive from a sender, the recipients transmit back the e-mail to the sender. With this, the sender can know the number of e-mails that the recipients do not desire to receive. Moreover, in case that the e-mail was transmitted to these recipients caused by some trouble, some measures preventing this trouble can be taken by the sender. Furthermore, in case that the sender transmits the e-mail to these recipients intentionally, the sender receives a large quantity of original e-mails by the transmission back, therefore, the sender itself must take some measures to avoid the heavy load to the server of the sender.

According to the second embodiment of the present invention, a storing means, in which e-mails refused by recipients have been stored in each of senders, is provided on a network. Therefore, any subscriber who can access to the network can collect information about the refused e-mails. Based on this information, the subscriber can widely and quickly investigate the actual situation of bothering e-mails, and the subscriber can make the sender and/or the Internet service provider connected to the sender take necessary measures to prevent transmitting bothering e-mails.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An e-mail communication system, comprising:
an e-mail transmitting means that transmits e-mails of each of subscribers to respective destinations;
an e-mail transmission refusal notice receiving means that receives a transmission refusal notice signifying that a specific e-mail is not desired to receive at each of said destinations and also showing the sender of said specific mail by an-e-mail;
a judging means that judges whether the number of said transmission refusal notices received at said e-mail transmission refusal notice receiving means for each of said senders in a designated period exceeds a predetermined threshold value or not; and
an e-mail transmission refusing means that refuses the transmission of e-mails from said sender from now on when said judging means judged that the number of said refusal notices for said sender exceeded said predetermined threshold value.

2. An e-mail communication system, comprising:
an e-mail transmitting means that transmits e-mails of each of subscribers to respective destinations;
an e-mail transmission refusal notice receiving means that receives a transmission refusal notice signifying that a specific e-mail is not desired to receive at each of said destinations and also showing the sender of said specific mail by an-e-mail;
a judging means that judges whether the ratio of the number of said transmission refusal notices received at said e-mail transmission refusal notice receiving means for said specific e-mail from each of said senders to the total transmitted number of said specific e-mail exceeds a predetermined threshold value or not; and
an e-mail transmission refusing means that refuses the transmission of e-mails from said sender from now on when said judging means judged that said ratio exceeded said predetermined threshold value.

3. An e-mail communication system in accordance with claim 1, further comprising:
an e-mail transmission refusal notice informing means that informs said sender who transmitted said specific e-mail being not desirable to receive about said transmission refusal notices received at said e-mail transmission refusal notice receiving means.

4. An e-mail communication system in accordance with claim 2, further comprising:
an e-mail transmission refusal notice informing means that informs said sender who transmitted said specific e-mail being not desirable to receive about said transmission refusal notices received at said e-mail transmission refusal notice receiving means.

5. An e-mail communication system in accordance with claim 1, further comprising:
a transmission refused sender memorizing means that memorizes each of said senders who were refused to transmit said e-mails from now on by said e-mail transmission refusing means; and
a threshold value changing means that makes said predetermined threshold value low when the memorized number of said sender in said transmission refused sender memorizing means increased.

6. An e-mail communication system in accordance with claim 2, further comprising:
a transmission refused sender memorizing means that memorizes each of said senders who were refused to transmit said e-mails from now on by said e-mail transmission refusing means; and
a threshold value changing means that makes said predetermined threshold value low when the memorized number of said sender in said transmission refused sender memorizing means increased.

7. An e-mail communication system, comprising:
a transmission refusal e-mail storing means that stores specific e-mails being not desirable to receive at each of destinations in each of senders when said specific e-mails being not desirable to receive were received at each of said destinations, provided in a network; and
an e-mail transmission stopping request transmitting means that investigates the number of said specific e-mails in each of said senders storing in said transmission refusal e-mail storing means and makes an Internet service provider connected to each of said senders stop transmitting e-mails from each of said senders from now on when the number of said specific e-mails exceeded a predetermined value in a designated period via said network.

8. An e-mail communication system in accordance with claim 7, further comprising:
a transmission refusal e-mail transmitting back means that transmits back said specific e-mails being not desirable to receive to each of said senders storing in said transmission refusal e-mail storing means.
